(19) United States
(12) Patent Application Publication
(10) Pub. No.: US 2008/0278284 A1
(43) Pub. Date: Nov. 13, 2008

(54) LOCKABLE DOCUMENT STORAGE SYSTEM AND METHODS OF USING THE SAME

(76) Inventor: George Sparks Milnor, II, Alton, IL (US)

Correspondence Address: Patrick W. Rasche;Armstrong Teasdale LLP, Suite 2600, One Metropolitan Square, St. Louis, MO, 63102, US

(21) Appl. No.: 11/745,912

(22) Filed: May 8, 2007

(51) Int. Cl. G06F 7/04; B65D 55/02; G05B 19/00

(52) U.S. Cl. 340/5.54

(57) ABSTRACT

Methods and systems of a lockable document storage system for communicating physical documents between an entity and a customer are provided. The system includes a plurality of document storage bins coupled together to form a modular document storage unit, a first access portal associated with more than one of the plurality of document storage bins, and a second access portal associated with each of the plurality of document storage bins wherein the second access portal includes at least one of a door and a drawer configured to control access to one of the plurality of document storage bins and wherein the at least one of a door and a drawer includes a reprogrammable locking device.

### BACKGROUND

The present invention generally relates to methods and systems for a lockable document storage system, and more particularly, to a lockable storage system for permitting unattended physical access only to authorized.

At least some known business transactions require the communication of physical documents between parties engaged in the transaction. For example, an insurance transaction may require communicating quotes for coverage, terms of coverage, and the execution of memorializing documents. At least some of the activities relating to the transaction may take place absent the other party. Other activities may require a transfer of documents between the parties, for example, for review of the documents or executing documents. However, schedules of the parties may make an in-person meeting of the parties difficult to arrange. In many cases, documents are simply mailed or sent via an overnight delivery service. However, postal delivery may be too slow a means of communicating documents for particular transactions and overnight delivery services may be costly for at least some transactions. In addition, a common meeting location may be easily accessible to both parties at different times such that delivery of the documents by a third party is not desirable.

What are needed are methods and systems that facilitate communicating documents between parties when a timely physical transfer of the documents between the parties is infeasible.

### SUMMARY

In one embodiment, a lockable document storage system for communicating physical documents between an entity and a customer includes a plurality of document storage bins coupled together to form a modular document storage unit, a first access portal associated with more than one of the plurality of document storage bins, and a second access portal associated with each of the plurality of document storage bins wherein the second access portal includes at least one of a door and a drawer configured to control access to one of the plurality of document storage bins and wherein the at least one of a door and a drawer includes a reprogrammable locking device.

In yet another embodiment, a method of communicating physical documents between an entity and a customer that includes depositing, by the entity, of at least one document into at least one of a plurality of document storage bins, wherein each the plurality of document storage bins includes a reprogrammable locking device associated with a first access portal to a respective one of the plurality of document storage bins. The method further includes programming a locking code into the reprogrammable locking device, communicating the unlocking code to the customer, and retrieving, by the customer, of the at least one document deposited into the at least one of the plurality of document storage bins using the unlocking code.

In another embodiment, a storage system for communicating physical articles between parties to a transaction that includes a plurality of storage bins coupled together to form a modular storage unit, a first access portal associated with more than one of the plurality of storage bins, and a second access portal associated with each of the plurality of storage bins, the second access portal including at least one of a door and a drawer, the at least one of a door and a drawer including a locking device that is programmable by one of the parties.

### BRIEF DESCRIPTION OF THE DRAWINGS

FIG. 1A is a front elevation view of a lockable document storage system 100 for communicating physical documents between an entity and a customer in accordance with an embodiment of the present invention;

FIG. 1B is a rear elevation view of the lockable document storage system shown in FIG. 1A;

FIG. 1C is a side section view of the lockable document storage system shown in FIG. 1A;

FIG. 2 is a perspective view of a lockable document storage system in accordance with another exemplary embodiment of the present invention;

FIG. 3 is a plan view of the lockable document storage system shown in FIG. 2;

FIG. 4 is a side sectional view of the lockable document storage system shown in FIG. 2; and

FIG. 5 is a flow diagram of an exemplary method of communicating physical documents between an entity and a customer.

### DETAILED DESCRIPTION

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure.

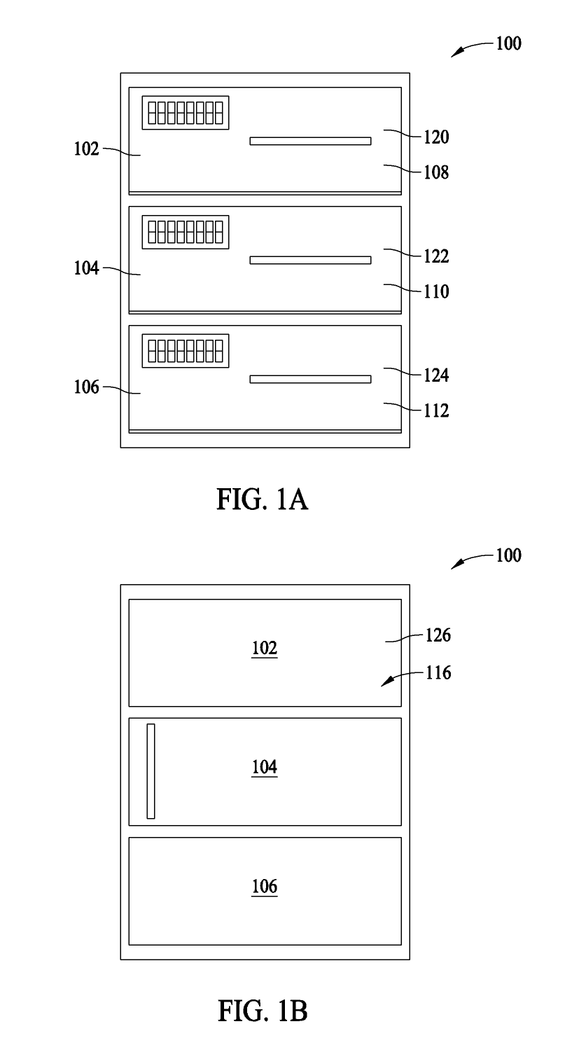

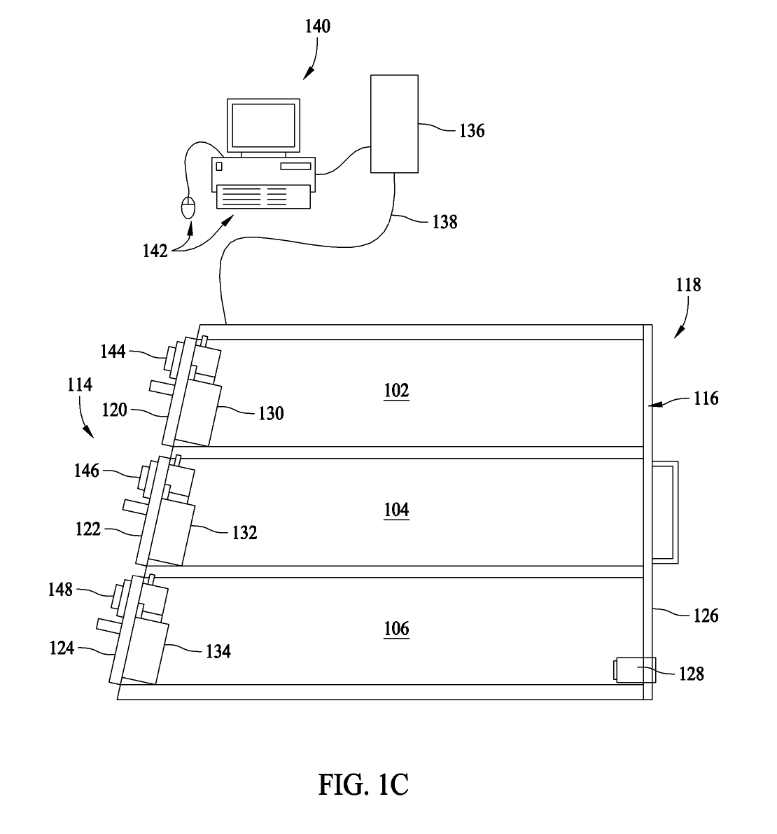

FIG. 1A is a front elevation view of a lockable document storage system 100 for communicating physical documents between an entity and a customer in accordance with an embodiment of the present invention. FIG. 1B is a rear elevation view of lockable document storage system 100 (shown in FIG. 1A) and FIG. 1C is a side section view of lockable document storage system 100 (shown in FIG. 1A). In the exemplary embodiment, system 100 includes a plurality of document storage bins 102, 104, and 106 coupled together to form a modular document storage unit. Although described as having three document storage bins, it should be understood that other numbers of document storage bins may be coupled together to form the modular document storage unit. In the exemplary embodiment, documents refer to physical articles that include, but are not limited to documents that include insurance related data and/or information, including text, photographs, charts, tables, spreadsheets and may include machine readable media including data and/or information as described above. Insurance related data and/or information includes health information, current insurance information, business information, financial information and any other information that may be used to recommend, determine and/or quote insurance rates or coverage. Each document storage bin 102, 104, and 106 includes a respective first access 108, 110, and 112 positioned at a front face 114 of system 100. A group of document storage bins 102, 104, and 106 also includes a second access 116 that permits access to the group through a rear face 118 of system 100. The group may include any number of document storage bins 102, 104, and 106. Whereas each respective first access 108, 110, and 112 is configured to provide access to only a respective document storage bin 102, 104, and 106, second access 116 is configured to provide access to a plurality of document storage bins 102, 104, and 106 simultaneously.

In the exemplary embodiment, each first access 108, 110, and 112 includes a door or in the case where document storage bins 102, 104, and 106 are formed as a drawer, each first access 108, 110, and 112 includes a drawer front 120, 122, and 124. Second access 116 includes a door 126. Opening door 126 permits access to a plurality of document storage bins 102, 104, and 106. Door 126 includes a lockable closure 128, such as but not limited to a keyed lock. Each of door 120, 122, and 124 includes an associated reprogrammable locking device 130, 132, and 134 that limits access to document storage bins 102, 104, and 106 to a customer that has knowledge of an unlocking code associated with one or more of the reprogrammable locking devices 130, 132, and 134. Locking devices 130, 132, and 134 are reprogrammable such that an entity that operates system 100 may change the unlocking code or combination of reprogrammable locking devices 130, 132, and 134 using a manual reprogramming procedure. The unlocking code may also be changed using an automatic procedure. For example, the unlocking code may automatically change after a predetermined number of entries to prevent further access to the associated document storage bins 102, 104, and/or 106. An automatic reset feature may be desirable when, for example, a customer is expected to open document storage bins 102, 104, or 106 a first time to retrieve documents placed inside document storage bins 102, 104, or 106 by a business entity and open document storage bins 102, 104, or 106 again to return the documents to document storage bins 102, 104, or 106 for later retrieval by the business entity. Because it is not expected that the customer will need to open the document storage bins 102, 104, or 106 a third time, the unlocking code may automatically change to a default unlocking code after the documents are placed back into document storage bins 102, 104, or 106 and the associated door 120, 122, or 124 is closed. The unlocking code may be selected by the entity and communicated to the customer via e-mail, postal delivery, telephone, fax, or other method.

In an alternative embodiment, unlocking and/or managing the unlocking codes for any of doors 120, 122, and 124 may be controlled through a controller 136 communicatively coupled to locking devices 130, 132, and 134. Controller 136 may be communicatively coupled to locking devices 130, 132, and 134 through a hardwire, wireless, fiber optic, or other signal transmission media 138 and may be coupled directly or through a network, such as, a LAN, a WAN, the Internet, or other network connection. A user interface 140 such as a PC or other computer, or a screen including pointing and selecting devices 142 such as, but not limited to a keyboard and/or mouse, or a touch screen may be used to enter an unlocking code into controller 136, which then sends an unlocking signal to the associated reprogrammable locking devices 130, 132, and 134. User interface 140 may also be used to reprogram or control reprogramming of reprogrammable locking devices 130, 132, and 134. As used herein, the term “controller” broadly refers to a processor, a computer, a microcontroller, a microcomputer, a programmable logic controller, an application specific integrated circuit, and any other programmable circuit. As used herein, the term “processor” may include any programmable system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “processor.”

Locking devices 130, 132, and 134 are configured to prevent access to an associated document storage bins 102, 104, or 106 until an unlocking condition is satisfied. Locking devices 130, 132, and 134 each include an input device 144, 146, and 148 configured to receive a mechanical entry to generate an unlocking condition, such as by pressing keys on a keypad by the customer. In an alternative embodiment, one of input devices 144, 146, and 148 may be associated with more than one reprogrammable locking device 130, 132, and 134 and may be configured to receive an entry from a user associated with a particular one of document storage bins 102, 104, or 106 to generate an unlocking condition for a respective one of document storage bins 102, 104, or 106. In an alternative embodiment, input devices 144, 146, and 148 are configured to receive an electronic entry to generate an unlocking condition. The unlocking code may be generated by the customer by entering a customer defined character sequence into controller 136. The unlocking code may also be generated by controller 136 randomly during a drop-off of initial documents by the customer.

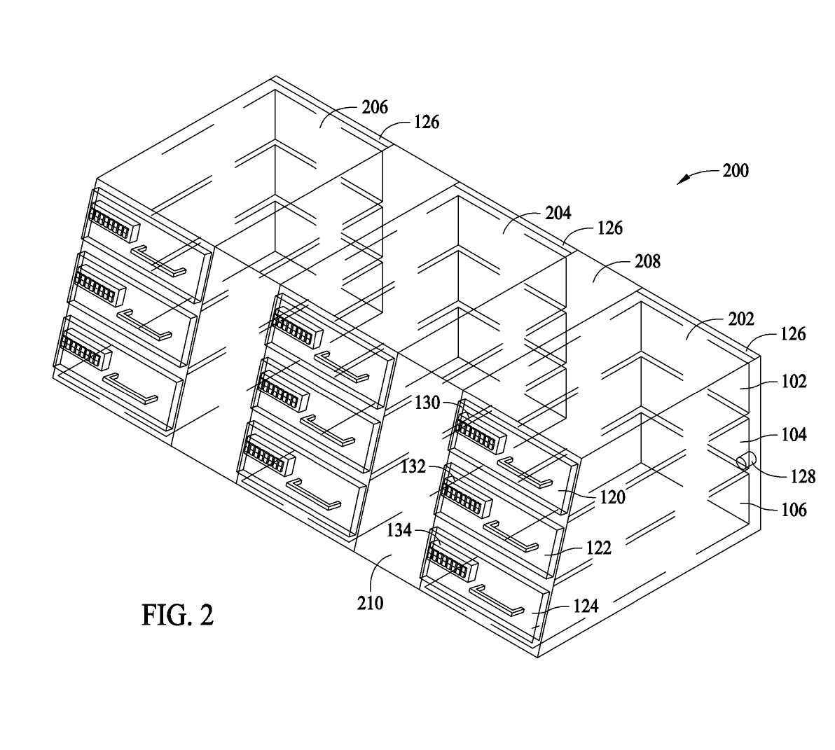

FIG. 2 is a perspective view of a lockable document storage system 200 in accordance with another exemplary embodiment of the present invention. In the exemplary embodiment, lockable document storage system 200 includes three modular document storage units 202, 204, and 206 coupled together to form a single lockable document storage system 200 in accordance with another exemplary embodiment of the present invention. Each modular document storage units 202, 204, and 206 includes a group of document storage bins 102, 104, and 106, each having an associated door 120, 122, and 124 wherein each associated door 120, 122, and 124 includes a respective reprogrammable locking device 130, 132, and 134. Each group of document storage bins 102, 104, and 106 also includes door 126 including a lockable closure 128, such as but not limited to a keyed lock.

Modular document storage units 202, 204, and 206 may be joined together using panels 208 and 210 to provide a coupling interface and separation between modular document storage units 202, 204, and 206 for ease of use. Panels 208 and 210 may be formed of, for example, but not limited to a wood product, metal, or plastic sheet such as Plexiglas™. In some embodiments, the plastic sheet is frosted or made translucent and may be used as a diffuser for a lamp positioned between document storage units 202, 204, and 206 for convenience or security lighting.

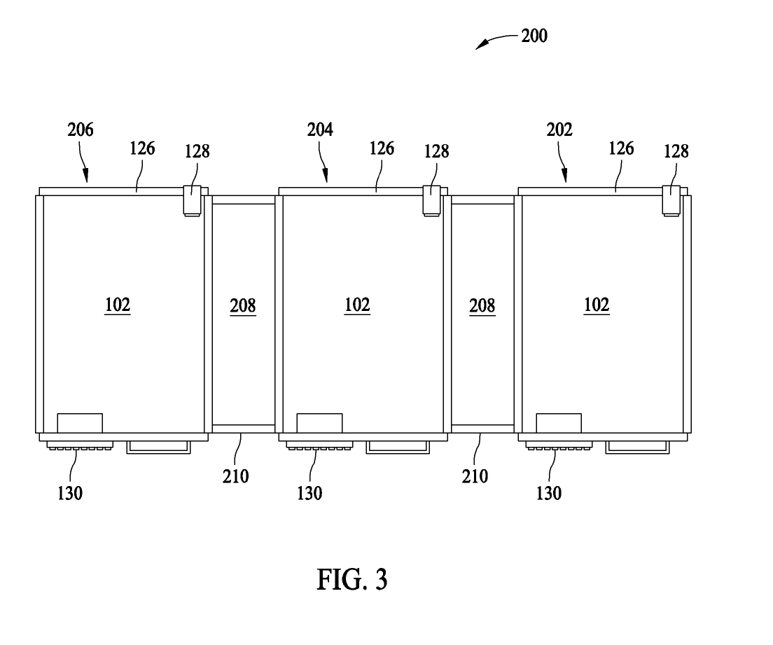

FIG. 3 is a plan view of lockable document storage system 200 (shown in FIG. 2). In the exemplary embodiment, lockable document storage system 200 includes three modular document storage units 202, 204, and 206 coupled together to form a single lockable document storage system 200 in accordance with another exemplary embodiment of the present invention. Each group of document storage bins in modular document storage units 202, 204, and 206 also includes door 126 including a lockable closure 128. Although illustrated coupled side by side, it should be noted that modular document storage units 202, 204, and 206 may be coupled together vertically stacked or a combination of side by side and vertically stacked. Additionally, any convenient number of document storage bins may be joined to form each modular document storage unit.

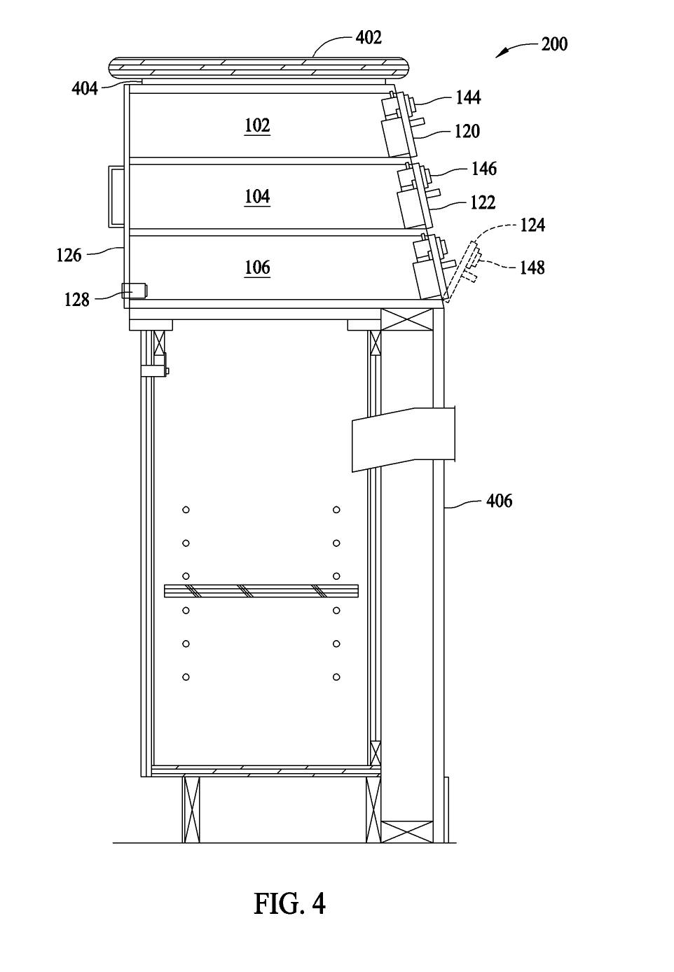

FIG. 4 is a side sectional view of lockable document storage system 200 (shown in FIG. 2). In the exemplary embodiment, lockable document storage system 200 includes a counter top 402 coupled to an upper surface 404 of modular document storage units 202, 204, and 206. Countertop 404 provides additional functional utility to modular document storage units 202, 204, and 206 in an office environment where floor space may be valuable. In the exemplary embodiment, modular document storage units 202, 204, and 206 may be mounted on top of a shelving unit 406 to provide additional utility and convenience by supporting modular document storage units 202, 204, and 206 at a height that is convenient for a user to access.

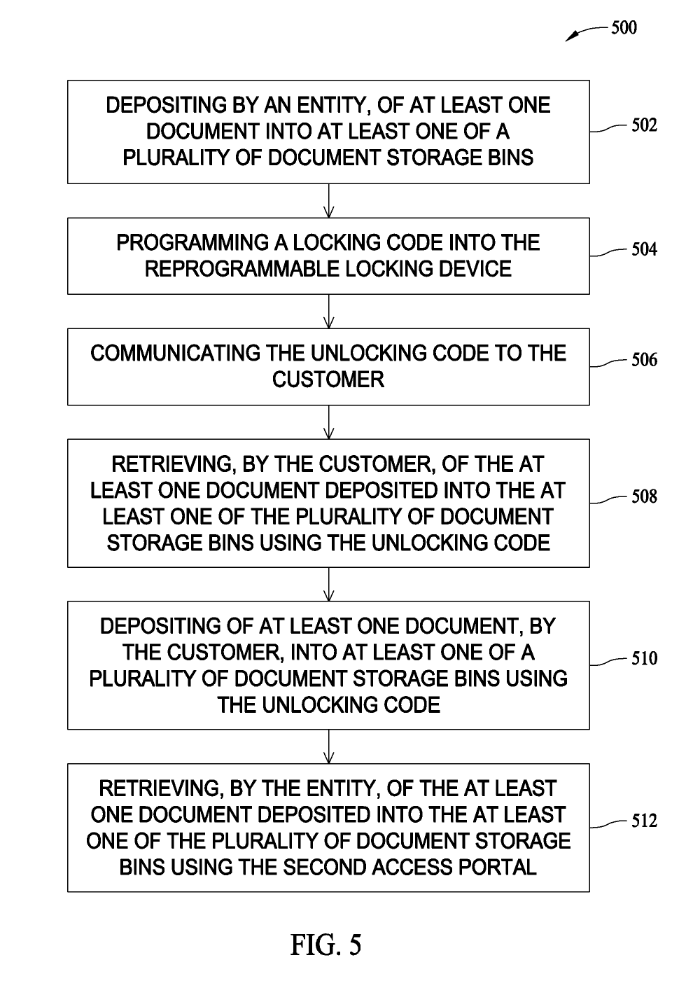

FIG. 5 is a flow diagram of an exemplary method 500 of communicating physical documents between an entity and a customer. Method 500 includes depositing 502, by the entity, of at least one document into at least one of a plurality of document storage bins, wherein each said plurality of document storage bins includes a reprogrammable locking device associated with a first access portal to a respective one of the plurality of document storage bins. Typically, the documents relate to a business transaction between the entity and the customer such as arranging for insurance coverage for the customer. The customer may drop off insurance related documents at the entity for consideration when the entity generates a quote for the transaction. In the exemplary embodiment, documents pertaining to a customer's present insurance coverage, health, financial and/or coverage preferences may be communicated using system 100. The entity may then work up a quote and may provide a contract in case the quote is acceptable to the customer. Method 500 also includes programming 504 a locking code into the reprogrammable locking device, communicating 506 the unlocking code to the customer, and retrieving, by the customer, of the at least one document deposited into the at least one of the plurality of document storage bins using the unlocking code. The unlocking code may be communicated to the customer through an e-mail, text message, instant message, telephone or voice message, or other means. Additionally, the unlocking code may be generated by the customer and communicated to the customer by acknowledging the customer's unlocking code selection. The code may also be generated randomly by controller 136 and displayed to customer or communicated to the customer as described above.

Method 500 further includes depositing 510 at least one document, by the customer, into at least one of the plurality of document storage bins using the unlocking code and wherein the plurality of document storage bins includes a second access portal, method 500 also includes retrieving, by the entity, the at least one document deposited into the at least one of the plurality of document storage bins using the second access portal.

The above-described methods and systems of communicating physical documents between an entity and a customer are cost-effective and highly reliable. The methods and systems include a document storage bin having a first lockable access for use by a customer and second access for use by the entity. The first lockable access includes a reprogrammable locking device and the second access is lockable and may provide access to a plurality of document storage bins. Accordingly, the methods and structures facilitate unattended access to physical documents by the customer to facilitate a business transaction between the entity and the customer in a cost-effective and reliable manner.

While embodiments of the disclosure have been described in terms of various specific embodiments, those skilled in the art will recognize that the embodiments of the disclosure can be practiced with modification within the spirit and scope of the claims.

What is claimed is:

1. A lockable document storage system for communicating physical documents between an entity and a customer, said system comprising:
a plurality of document storage bins coupled together to form a modular document storage unit;
a first access portal associated with more than one of said plurality of document storage bins; and
a second access portal associated with each of said plurality of document storage bins, said second access portal comprising at least one of a door and a drawer configured to control access to one of the plurality of document storage bins, said at least one of a door and a drawer comprising a reprogrammable locking device.

2. A system in accordance with claim 1 wherein the reprogrammable locking device is configured to prevent access to an associated storage bin until an unlocking condition is satisfied.

3. A system in accordance with claim 1 wherein the reprogrammable locking device comprises an input device associated with the reprogrammable locking device, said input device configured to receive a mechanical entry to generate an unlocking condition.

4. A system in accordance with claim 1 wherein the reprogrammable locking device comprises an input device associated with more than one reprogrammable locking device, said input device configured to receive an entry from a user associated with a particular one of said plurality of document storage bins to generate an unlocking condition for a respective one of said plurality of document storage bins.

5. A system in accordance with claim 1 wherein the reprogrammable locking device comprises an input device configured to receive an electronic entry to generate an unlocking condition.

6. A system in accordance with claim 5 wherein said input device comprises a keypad, said keypad configured to receive an unlocking code manually entered by a user into said keypad.

7. A system in accordance with claim 5 further comprising a controller communicatively coupled to said input device and wherein said input device is configured to receive an unlocking code from at least one of a user and said controller.

8. A system in accordance with claim 7 wherein said controller comprises a user interface, said user interface configured to receive an input from a user and determine whether the input comprises an unlocking code.

9. A system in accordance with claim 8 wherein said controller is configured to communicate with a plurality of reprogrammable locking devices such that one of the plurality of reprogrammable locking devices is unlocked permitting access to one of said plurality of document storage bins when an associated unlocking code is entered into said user interface.

10. A method of communicating physical documents between an entity and a customer, said method comprising:
depositing, by the entity, of at least one document into at least one of a plurality of document storage bins, wherein each said plurality of document storage bins includes a reprogrammable locking device associated with a first access portal to a respective one of the plurality of document storage bins;
programming a locking code into the reprogrammable locking device;
communicating the unlocking code to the customer; and
retrieving, by the customer, of the at least one document deposited into the at least one of the plurality of document storage bins using the unlocking code.

11. A method in accordance with claim 10 wherein the at least one document includes insurance related information including at least one of health information, current insurance information, business information, financial information and any other information that may be used to at least one of recommend, determine and quote insurance rates or coverage.

12. A method in accordance with claim 10 wherein the at least one document includes insurance related information including information relating to at least one of health insurance, life insurance, automobile insurance, homeowners insurance, fire and casualty insurance, earthquake insurance, business insurance, and renter's insurance.

13. A method in accordance with claim 10 further comprising depositing at least one document, by the customer, into the at least one of a plurality of document storage bins using the unlocking code.

14. A method in accordance with claim 10 further comprising generating an unlocking code by at least one of the customer, the entity, and the controller wherein the unlocking code is generated at least one of randomly and based on an input from the customer.

15. A method in accordance with claim 13 wherein the plurality of document storage bins includes a second access portal, different than the first access portal, said method further comprising retrieving, by the entity, of the at least one document deposited into the at least one of the plurality of document storage bins using the second access portal.

16. A storage system for communicating physical articles between parties to a transaction, said system comprising:
a plurality of storage bins coupled together to form a modular storage unit;
a first access portal associated with more than one of said plurality of storage bins; and
a second access portal associated with each of said plurality of storage bins, said second access portal comprising at least one of a door and a drawer, said at least one of a door and a drawer comprising a locking device that is programmable by one of the parties.

17. A system in accordance with claim 16 wherein the locking device comprises an electronically actuated lock.

18. A system in accordance with claim 16 wherein the locking device comprises a mechanically actuated lock.

19. A system in accordance with claim 16 wherein the system is positioned in an insurance office.

20. A system in accordance with claim 16 wherein said physical articles comprise insurance related documents, wherein insurance documents include information that may be used to determine at least one of insurance coverage, rates, term, acceptance, conditions, payment plan.

21. A system in accordance with claim 16 wherein the locking device comprises an actuator configured to unlock said at least one of a door and a drawer when an unlocking code is received by the actuator.

22. A system in accordance with claim 16 wherein an unlocking code is configured to reset to a predetermined other unlocking code when the unlocking code is entered a predetermined number of times.

23. A system in accordance with claim 16 wherein the locking device comprises an input device associated with the locking device, said input device configured to receive an entry from at least one of one of the parties to generate an unlocking condition.

24. A system in accordance with claim 16 comprising an input device associated with a plurality of locking devices, said input device configured to receive an entry from a user, the entry associated with a particular locking device to generate an unlocking condition for the particular locking device.

25. A system in accordance with claim 24 wherein said input device comprises a keypad, said keypad configured to receive an unlocking code manually entered by a user into said keypad.

26. A system in accordance with claim 24 further comprising a controller communicatively coupled to said input device wherein said input device is configured to receive an unlocking code from at least one of a user and the controller.

27. A system in accordance with claim 26 wherein said controller comprises a user interface, said user interface configured to receive an input from a user and determine whether the input comprises an unlocking code.

28. A system in accordance with claim 27 wherein said controller is configured to communicate with a plurality of locking devices such that one of the plurality of locking devices is unlocked permitting access to one of said plurality of storage bins when an associated unlocking code is entered into said user interface.
